(19) United States
(12) Patent Application Publication
(10) Pub. No.: US 2006/0117121 A1
(43) Pub. Date: Jun. 1, 2006

(54) Recording/reproducing apparatus and method of controlling the same

(75) Inventors: Yuichi Togashi, Tokyo (JP); Kouichi Ogi, Hanno-shi (JP); Masami Tanaka, Ome-shi (JP); Naruki Nakase, Ome-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/266,226

(22) Filed: Nov. 4, 2005

(30) Foreign Application Priority Data
Nov. 30, 2004 (JP) 2004-347317

(51) Int. Cl. G06F 13/12

(52) U.S. Cl. 710/74

(57) ABSTRACT

There is disclosed a recording/reproducing apparatus configured to receive an operation instruction supplied via a communication network, to execute a corresponding operation in accordance with an operation instruction obtained by analyzing contents of the received operation instruction, and to announce a result of executing the operation instruction to an operation instruction supply source. Accordingly, a state of the recording/reproducing apparatus is known from the outside, whereby the recording/reproducing apparatus can be operated.

### CROSS-REFERENCE TO RELATED APPLICATIONS

This application is based upon and claims the benefit of priority from prior Japanese Patent Application No. 2004-347317, filed Nov. 30, 2004, the entire contents of which are incorporated herein by reference.

### BACKGROUND OF THE INVENTION

1. Field of the Invention

The present invention relates to a recording/reproducing apparatus capable of recording and reproducing information, and more particularly to a recording/reproducing apparatus and an information recording/reproducing method capable of setting a start and an end of recording information, or editing or the like in the recording/reproducing apparatus from the outside.

2. Description of the Related Art

For example, in a recording/reproducing apparatus for executing reproducing/recording on a recording medium on which video data containing image information, voice information and the like as well as control information are recorded, when there are set a recording start date/recording end date, a recording source (supply source), a recording rate and a recording system (voice recording form), and the like (abbreviated to “recording reservation conditions” hereinafter) by an apparatus main body or an accessory remote controller, information is recorded from the desired (set) recording source in accordance with the predetermined recording rate and system on the reserved date.

Today, popularization of communication networks has brought about a proposal of a recording/reproducing apparatus capable of receiving recording reservation conditions supplied through the communication network, and recording information indicated by the recording reservation conditions in accordance with the same.

For example, Jpn. Pat. Appln. KOKAI Publication No. 2002-27371 has proposed a recording/reproducing apparatus capable of receiving electronic mail supplied from a portable telephone through the Internet, converting the received electronic mail into timer reservation setting information, and setting reserved recording. According to the apparatus, when recording is finished, a recording end mail can be transmitted to the portable telephone.

For example, to receive electronic mail through the Internet, Jpn. Pat. Appln. KOKAI Publication No. 2004-186809 has proposed a recording/reproducing apparatus for starting an apparatus main body to receive the electronic mail by a main power source internal controllable type switch which can start an operation other than that of a secondary circuit of the apparatus main body by predetermined timing.

For example, Jpn. Pat. Appln. KOKAI Publication No. 2004-286720 has proposed a recording/reproducing apparatus capable of returning impossibility of reservation when recording reservation cannot be made for recording control information contained in received mail.

The Publication No. 2002-27371 discloses that the recording/reproducing apparatus can receive the electronic mail through the Internet, convert the received electronic mail into the timer reservation setting information, and set the reserved recording. However, there is no description regarding, e.g., editing of recorded information, transfer (duplication) from a hard disk to an optical disk of a DVD standard or the like (between media) while the recording/reproducing apparatus is not operated (standby time).

The Publication No. 2004-186809 discloses that the recording/reproducing apparatus can start the apparatus main body by the predetermined timing to receive the electronic mail. However, particularly as in the case of the Patent Document 1, there is no description regarding, e.g., editing of recorded information, transfer (duplication) between media, or the like while the recording/reproducing apparatus is not operated (standby time).

The Publication No. 2004-286720 discloses that the recording/reproducing apparatus returns the impossibility of reservation when reservation cannot be made for the recording control information instructed by the received electronic mail. However, there is no description regarding, e.g., editing of recorded information, transfer (duplication) between media, or the like while the recording/reproducing apparatus is not operated (standby time).

### BRIEF SUMMARY OF THE INVENTION

An aspect of the present invention provides a recording/reproducing apparatus which records information or reproduces recorded information, comprising:

instruction reception means for receiving an operation instruction supplied from the outside;

analysis means for analyzing contents of the operation instruction received by the instruction reception means;

control means for executing an operation corresponding to the operation instruction in accordance with the operation instruction analyzed by the analysis means; and

result announcing means for announcing a result of executing the operation instruction under control of the control means to an optical instruction supply source.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a schematic diagram showing an example of a method of remote-operating a recording/reproducing apparatus by electronic mail according to an embodiment of the present invention;

FIG. 2 is a schematic diagram showing an example of the remote-operation shown in FIG. 1; and

FIG. 3 is a schematic diagram showing another example of the remote-operation shown in FIG. 1.

### DETAILED DESCRIPTION OF THE INVENTION

Hereinafter, the preferred embodiment of the present invention will be described with reference to the accompanying drawings.

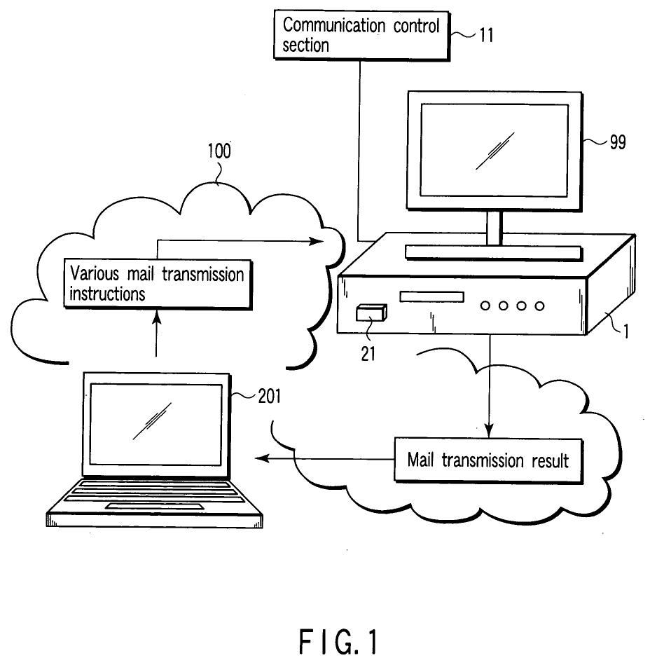

FIG. 1 shows an example of a configuration of remote-operating a recording/reproducing apparatus by, e.g., electronic mail, from the outside.

Referring to FIG. 1, a recording/reproducing apparatus 1 is connected through a communication network 100 to a communication control section 11 which can transmit/receive electronic mail (not described in detail), and a communication terminal 201 which can transmit/receive electronic mail from the outside by turning on a main power source internal controllable type switch 21 when an instruction of turning on the main power source internal controllable type switch 21 is contained in an instruction supplied in a mail form from the outside in an off state of a main power source.

For example, the mail terminal 201 is a personal computer or a portable telephone, and there is no particular limitation thereon as long as it can transmit/receive mail.

For example, the communication network 100 is the Internet, and provides an environment which enables the recording/reproducing apparatus 1 to receive (communicate) mail transmitted from the mail terminal 201. Needless to say, the communication network may be a local area network or the like.

For example, the recording/reproducing apparatus 1 is a hard disk drive (abbreviated to “HDD” hereinafter) capable of recording information on a hard disk, and can record a video or voice information supplied from an information supply source (distribution source) through a broad casting, a cable or the like for a predetermined period (several hundred hours today). The recording/reproducing apparatus 1 has a scheduling function (holding of reservation and data management by timer). Accordingly, when the time designated by the timer is detected, a pre-instructed optional operation (reserved recording or the like) is executed.

A display unit 99 capable of displaying image information or control information to be recorded (picture-recorded) by the recording/reproducing apparatus can be connected to the recording/reproducing apparatus 1. For the display unit 99, an optional unit such as a liquid crystal display (LCD), a CRT monitor, a television receiver, or the like capable of displaying a video can be used.

First, an operation of transmitting various pieces of instruction mail from the mail terminal 201 to the recording/reproducing apparatus 1 will be described.

At the mail terminal 201, instruction mail is created in a predetermined format.

The instruction mail is transmitted from the mail terminal 201. The transmitted mail is stored in a server (not shown) in accordance with rules of the communication network. If the mail terminal is a portable telephone, arrival of the instruction mail is informed from the server (not shown) to the information recording/reproducing apparatus 1.

If mail contents are in a specific form, the recording/reproducing apparatus 1 holds a mail analysis program to enable execution of a predetermined operation instructed by the mail contents, receives the instruction mail from the communication network by predetermined timing, and analyzes the mail contents.

Accordingly, the recording/reproducing apparatus 1 executes operations instructed by the received mail, such as addition of new recording reservation and editing or transfer of recorded information between media (duplication).

Next, an operation of transmitting result mail from the recording/reproducing apparatus 1 to the mail terminal 201 (return operation) will be described.

At the communication control section 11 of the recording/reproducing apparatus 1, result mail is created in a predetermined format.

The created result mail is transmitted toward the server (not shown) of the communication network, and stored therein.

Accordingly, an operation result of the recording/reproducing apparatus 1 can be checked on the mail terminal 201 side.

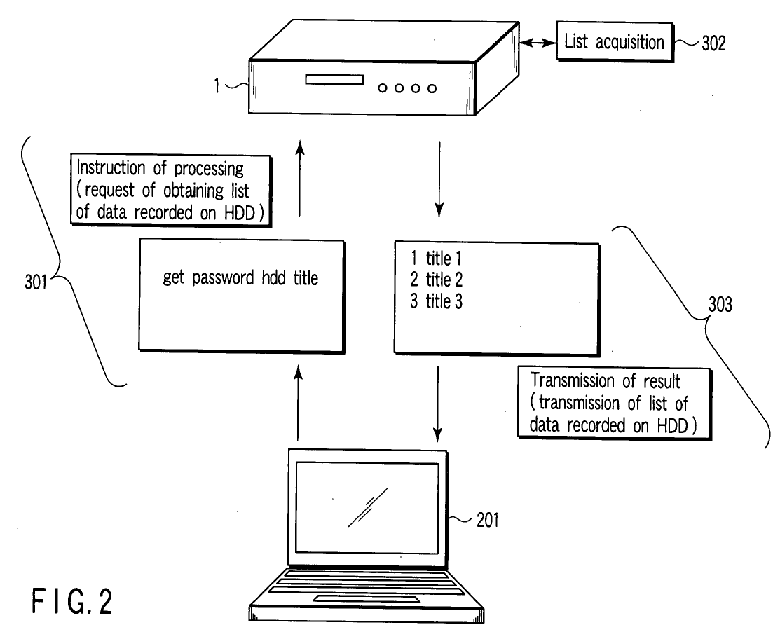

FIG. 2 shows a flow of an operation by taking an example of instructing the recording/reproducing apparatus 1 from the mail terminal 201 to obtain a list of data recorded on a HDD or the like.

For example, mail of contents of instructing acquisition of “list of recorded data” present on the HDD or the like is transmitted from the mail terminal 201 to the recording/reproducing apparatus 1 (301). As mail contents, a well-known command group, called a “batch file”, e.g., those such as “get password hdd title” which cannot be realized by a remote controller (not shown) or an input unit such as a button or a dial disposed on the apparatus 1 main body may be contained. If command processing takes a certain period of time, a command such as WAIT may be used.

In the recording/reproducing apparatus 1, mail is received by predetermined timing or at regular time intervals, and contents of the mail are analyzed. In other words, in the example of FIG. 2, Facquisition of “list of recorded data” on the HDD and transmission of the “list” j are instructed.

In the recording/reproducing apparatus 1, based on an instruction of received mail, “list of recorded data” is obtained (302), and the “list” is transmitted (303).

On the mail terminal 201 side, access is made to the server of the communication network to receive result mail from the recording/reproducing apparatus 1.

Accordingly, it is possible to obtain the “list of recorded data” on the HDD of the recording/reproducing apparatus 1 from the outside.

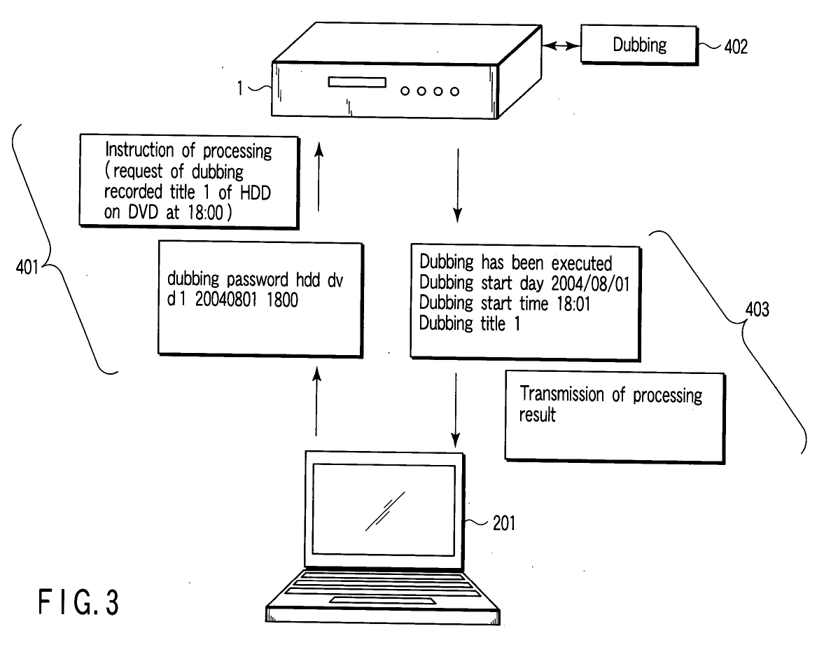

FIG. 3 shows an example of instructing dubbing from the mail terminal 201 to the recording/reproducing apparatus 1.

From the mail terminal 201, mail of contents of instructing “dubbing (duplication) of title of recorded data” on the HDD of the recording/reproducing apparatus 1, and “time” of executing the dubbing is transmitted (401).

In the recording/reproducing apparatus 1, the contents of the received mail are analyzed.

A check is made as to overlapping of an operation obtained from the analysis to be executed with another operation held by the recording/reproducing apparatus 1 side. In other words, a check is made as to overlapping of time of recording reservation instructed to the recording/reproducing apparatus 1 with the instructed time.

In the recording/reproducing apparatus 1, if the operation instructed by the mail is executable, the operation is finished (402), and then result mail indicating the end of the operation is transmitted (403).

In the recording/reproducing apparatus 1, if a result of mail check determines that the operation instructed by the mail cannot be executed (because of another operation which has been instructed), response mail indicating the impossibility of execution is transmitted.

At the mail terminal 201, the mail is received, whereby an end of the dubbing or nonexecution (response mail) can be known.

Needless to say, there is no limitation on kind of mail instructions as long as their contents can be executed by the normal recording/reproducing apparatus 1, such as “transfer of specific data (information) recorded on HDD to DVD-RAM disk, and deletion of data from HDD”. For example, during dubbing, recording or the like by a bit rate different from a recorded bit rate may be instructed.

As described above, according to the recording/reproducing apparatus of the present invention, by obtaining recording reservation mail containing recording conditions, it is possible to set a start and an end of recording information under difficult conditions of recording reservation by the apparatus main body or the remote controller. For example, a state of the recording/reproducing apparatus is known from the outside or the like to enable execution of various operations.

When instruction mail nonexecutable because of overlapping with another operation instructed to the recording/reproducing apparatus is received, by the scheduling function, it is possible to set an operation to prevent overlapping with reserved recording based on recording reservation, or to combine a plurality of operations.

In the case of an apparatus capable of outputting an end sound or the like, it can be applied to various apparatuses in addition to the recording/reproducing apparatus.

The present invention is not limited to the foregoing embodiment, and various changes and modifications can be made without departing from the gist of the invention at its implementation stage. Furthermore, individual embodiments can be combined appropriately, and in this case, effects created by the combination can be obtained.

For example, FTP, HTTP, or the like can be used in place of mail instruction.

The present invention is not limited to the embodiments described above and can be modified in various manners without departing from the spirit and scope of the invention.

For example, the present invention can provide:

A method of controlling a recording/reproducing apparatus which records information or reproduces already recorded information, comprising:

receiving an operation instruction supplied from the outside;

analyzing contents of the received operation instruction; and

announcing impossibility of executing an operation corresponding to the designated operation instruction to an operation instruction supply source when overlap of the analyzed operation instruction with another already designated operation is detected.

What is claimed is:

1. A recording/reproducing apparatus which records information or reproduces recorded information, comprising:
instruction reception means for receiving an operation instruction supplied from the outside;
analysis means for analyzing contents of the operation instruction received by the instruction reception means;
control means for executing an operation corresponding to the operation instruction in accordance with the operation instruction analyzed by the analysis means; and
result announcing means for announcing a result of executing the operation instruction under control of the control means to an optical instruction supply source.

2. The recording/reproducing apparatus according to claim 1, wherein the instruction reception means is configured to receive a command group supplied through a communication network.

3. The recording/reproducing apparatus according to claim 1, wherein the control means is configured to access the communication network to announce thereto a check and a result of presence of the operation instruction.

4. The recording/reproducing apparatus according to claim 1, wherein the control means is configured to announce impossibility of executing an instructed operation which overlaps with another already designated operation when the control means has received the instruction of the instructed operation.

5. The recording/reproducing apparatus according to claim 1, wherein the control means is configured to hold already reserved date information, to manage a date, and to check that the instructed operation overlaps with the reserved date information.

6. A method of controlling a recording/reproducing apparatus which records information or reproduces already recorded information, comprising:
receiving an operation instruction supplied from the outside;
analyzing contents of the received operation instruction;
executing an operation corresponding to the operation instruction in accordance with the analyzed operation instruction; and
announcing a result of executing the operation instruction to an operation instruction supply source.

7. A recording/reproducing apparatus comprising:
fetching means, for fetching mail from the outside, which is configured to fetch recording reservation mail containing recording contents written therein from the outside; and
registration means for registering recording reservation in accordance with the recording contents obtained by the fetching means.

8. The recording/reproducing apparatus according to claim 7, wherein the fetching means fetches the recording reservation mail through a network.

9. The recording/reproducing apparatus according to claim 7, further comprising:
an announcing mechanism configured to announce contents of the recording reservation mail fetched by the fetching means to the outside.
